(19) United States
(12) Patent Application Publication
(10) Pub. No.: US 2016/0267714 A1
(43) Pub. Date: Sep. 15, 2016

(54) Apparatus and Method for Mutli-Layered Graphical User Interface for Use in Mediated Reality

(71) Applicant: LAFORGE Optical, Inc., Venice, CA (US)

(72) Inventors: Corey Mack, Venice, CA (US); William Kokonaski, Gig Harbor, WA (US)

(21) Appl. No.: 15/067,831

(22) Filed: Mar. 11, 2016

Related U.S. Application Data
(60) Provisional application No. 62/132,052, filed on Mar. 12, 2015.
(60) Provisional application No. 62/191,752, filed on Jul. 13, 2015.

(51) Int. Cl. G06T 19/00; G06T 11/60; G06N 3/02; G06T 15/20; G06T 19/20; G06F 3/0481; G06F 3/01

(52) U.S. Cl. CPC G06T 19/006; G06F 3/04815; G06T 19/003; G06T 11/60; G06F 3/013; G06T 15/20; G06T 19/20; G06F 3/016; G06N 3/02; G06T 2219/008

(57) ABSTRACT

Disclosed are methods and devices for displaying a virtual image in a field of vision of a user without the use of an image sensor. In an embodiment, the device receives first data identifying a user's first location and uses the first data to estimate the user's first location. The estimate of the user's first location is then used to identify at least one user interface element or active element within the user's field of vision. The at least one user interface element or active element is associated with one of a plurality of layered planes in a virtual space. A first version of the user interface element or active element is displayed within a first field of vision of the user. The user's updated location is then used to update the appearance of the representation of the user interface element or active element within a second field of vision of the user.

This application is a non-provisional of and claims priority from U.S. Patent Application Ser. No. 62/132,052 filed 12 Mar. 2015, which is incorporated herein by reference in its entirety. This application also claims priority to U.S. Provisional Patent Application No. 62/191,752 filed 13 Jul. 2015, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of mediated reality and in particular to a multi-layered Graphical User Interface (GUI) for use therein.

### BACKGROUND

Mediated reality experiences and augmented reality experiences in particular allow for user to see and interact with the world in a way that has yet to be fully explored. Currently there are several computer vision based techniques and apparatuses that allow users to see contextually relevant data overlaid on their field of vision. Many of these are resource intensive and need significant processing power for smooth and reliable operation.

Currently, most apparatus for augmented reality and other mediated reality experience are bulky and expensive, as most augmented reality applications are attempting to create a higher fidelity experience than the ones that are currently existing. The present invention is a method that allows for lower on-board or external processing of what is occurring in the real world in order to render or draw, and is also scalable based on the available bandwidth or processing power for a more consistent user experience.

### SUMMARY

Disclosed is a computer-implemented method that, in an embodiment, yields an immersive mediated reality experience by layering certain graphical user interface elements or active elements running in a real time computing application. The method and apparatus allow a user to traverse real 3D space and have certain overlaid bits of information appear at appropriate scale, projection, and time based on a desired application. Since this system does not use an image sensor to place images, a gain in performance may be yielded via the lower processing demands.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a view of the user's field of vision with certain computer based graphics overlaid.

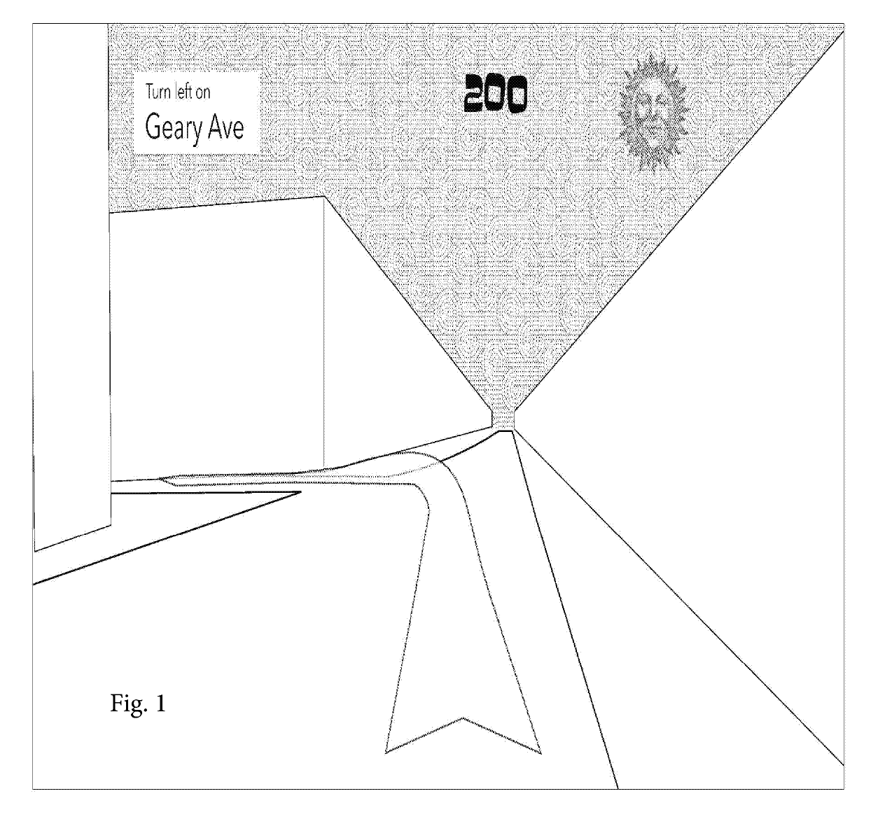

FIG. 2 shows a system in accordance with an embodiment of the invention detailing the function of the layers and a map.

FIGS. 3 and 3A show a system in accordance with an embodiment of the invention detailing a function of the layers.

FIG. 4 Shows an alternate system in accordance with an embodiment of the invention detailing a function of the layers.

FIG. 4A shows an alternate system in accordance with an embodiment of the invention detailing a function of the layers.

FIG. 5 shows a visual comparison of two embodiments of the invention detailing variable layer density.

FIG. 5A shows a visual comparison of two embodiments of the invention detailing variable layer density.

FIG. 6 shows a visual comparison of two embodiments of the invention detailing variable layer scaling.

FIG. 7 shows a view of the user's field of vision, showing a function of the invention from the perspective of the computer overlaid.

FIG. 8 shows a view of the user's field of vision, showing a function of the invention from the perspective of the computer overlaid, with an additional GUI element overlaid.

FIG. 9 shows a view of the user's field of vision, showing a function of the invention from the perspective of the computer overlaid, with an additional GUI element overlaid.

FIG. 10 shows a view of the user's field of vision, showing a function of the invention from the perspective of the computer overlaid, with an additional GUI element overlaid and mapping points applied.

FIG. 10A shows an illustration of a vectorized image that has not been transformed

FIG. 11 shows a view of the user's field of vision, showing a function of the invention from the perspective of the computer overlaid, with an additional GUI element overlaid.

FIG. 12 shows a view of the user's field of vision, showing a function of the invention from the perspective of the computer overlaid, with an additional GUI element overlaid and mapping points applied.

FIG. 13 shows a view of the user's field of vision, showing a function of the invention from the perspective of the computer overlaid, with an additional GUI element overlaid and mapping points applied.

FIG. 14 illustrates processing operations associated with an embodiment of the invention.

FIG. 15 illustrates additional processing operations associated with an embodiment of the invention.

FIG. 16 illustrates additional processing operations associated with an embodiment of the invention.

FIG. 17 illustrates a system in accordance with an embodiment of the invention.

FIG. 18 illustrates an alternate system in accordance with an embodiment of the invention.

FIGS. 19 and 20 illustrates an alternate system in accordance with an embodiment of the invention.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one embodiment or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of devices and methods for providing a multi-layered GUI in a mediated reality device. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

Examples of augmented reality eyewear to which the present invention may be applied are disclosed in U.S. application Ser. No. 14/610,930 filed Jan. 30, 2015, the entire disclosure of which is incorporated herein by reference.

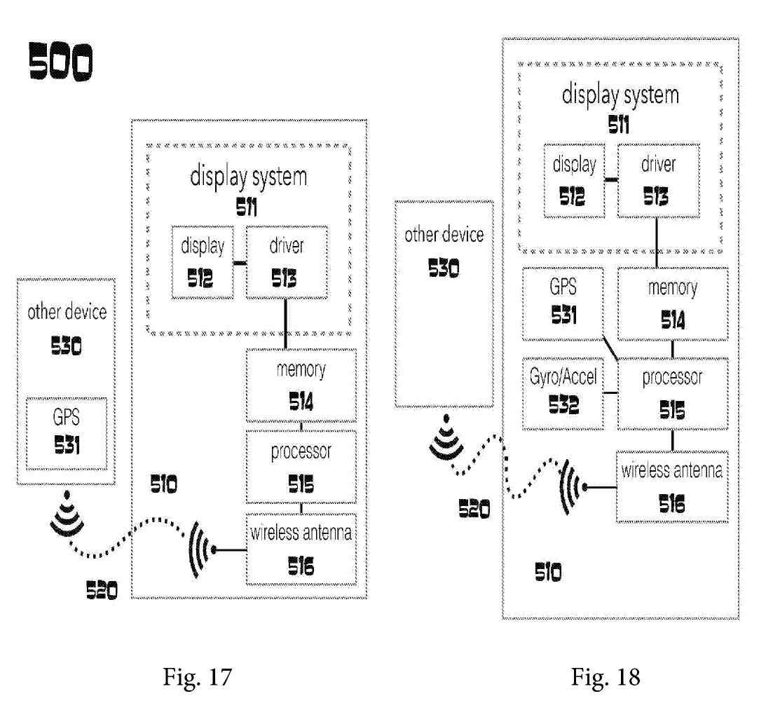

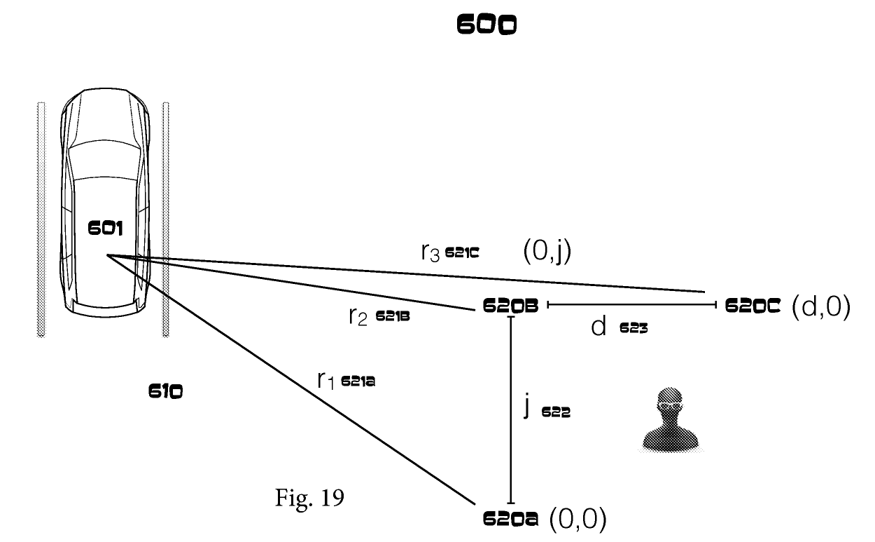

FIG. 17 illustrates an embodiment of the invention where most of the processing would be handled on a device 530 that is separate from the primary augmented reality eyewear device 510. Examples of the separate device 530 include a smartphone, tablet, laptop or similar device capable of taking a stream of location based data such as GPS 531, processing it by performing a calculation or function and sending an output to the primary device 510. In the embodiment shown, a wireless signal 520 can be used to convey data to the primary device 510 to be received at its wireless antenna 516. In other cases, the data may be sent via any wired or tethered method. The primary device 510 may be any device or system that is capable of receiving data from a stream of location based data, and processing this data such that some output may be displayed on a display system 511. In the case shown in FIGS. 17 and 18, the display system consists of a display driver 513 that takes data and commands from the processor and formats it to be rendered on a display 512. Note that the display system may have other optical elements such as a lens, light pipes, reflective surface, or some other apparatus attached to it to convey this data to a user's eye. As shown in FIGS. 17 and 18, memory 514 may be used to improve the operation of the processor 515 and display system 511. FIG. 18 shows a preferred embodiment where more processing is being performed on-board the device. Additional sensors such as GPS 531 and a multiple axis gyro and accelerometer 532 have been added. Other components that may be added include, but are not limited to, humidity sensors, infrared sensors, acoustic sensors, and light sensors. Note that in the embodiment of the primary device 510 illustrated that device may communicate with another device 530 wirelessly. Note that this invention does not rely on the use of an image sensor for its operation. In some embodiments; however, it may be advantageous to include one of a number of methods of eye tracking technologies. Eye tracking can be used to localize content within a given scene or plane, or to adjust, rotate, translate or transform the sequence of planes displayed before the user based on what they are actually looking at within the scene. Eye tracking methods are well known to those normally skilled in the art and could be readily adapted for use with the present invention.

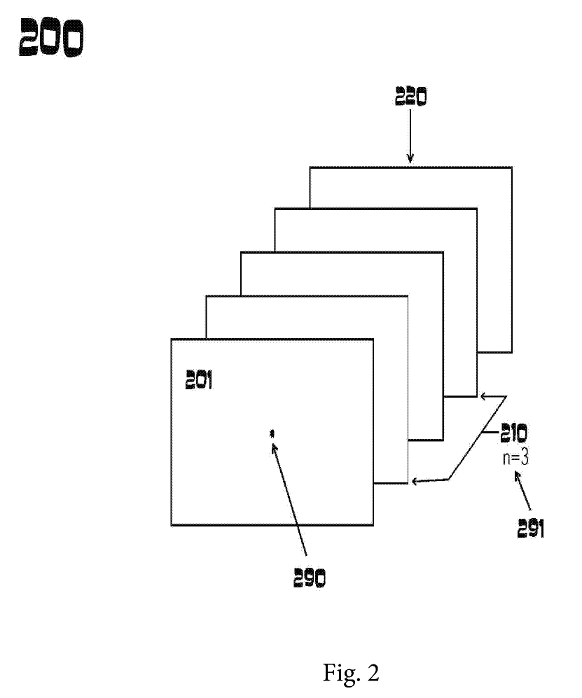

With reference to FIG. 2, on the left side one can see an illustration of an embodiment of the invention 200 that consists of layered planes. In this illustration, there are three types of layers: a dynamic instrument layer 201, dynamic element layers 210, and a horizon layer 220. The system may consist of at least two of these layer types. Note that the layers 201, 210, and 220 are invisible to the wearer of the device and are illustrated as visible so they and their operation can more easily understood. The dynamic instrument layer 201 is the layer that would display graphical elements such as time, a user's speed, a mini-map etc. One may also define the dynamic instrument layer as a layer of data that display formatted or styled data coming directly from an on board sensor, that is not placed with respect to any real element in the cameras line of vision. These elements may be animated but their position relative to the user's field of vision may be in most cases unchanged. The dynamic element layers 210, are layers of information where 2D or 3D graphics can be drawn or rendered, and may operate independently of one another, co-dependently, operate sequentially meaning activating on layer at a time in succession, or simultaneously. The horizon layer 220 is meant to be the last layer but may not be used in certain circumstances. The horizon layer 220 is also meant to display or render graphical elements that are at or near ‘infinity’ or on or beyond the horizon. For example, when one would be driving a car with a device using the invention 200 and he or she looks at a mountain range in the distance, the viewer may want to have information relevant to the summit of the mountain display on or above the mountain. Similarly, one may look towards the nights' shy and want to render constellation information, this information would be rendered on the horizon layer 220. In most cases the horizon layer would have little to no scaling factor 412 applied to it as the distances are sufficiently far away that their relative distance changes only infinitesimally or at a very slow rate. That being stated, the horizon layer would primary be responsible for translation of the central coordinate 290 of points mapped on its axes and projecting and other transforming those points on its axes in order to compensate for the user changing the direction they heading.

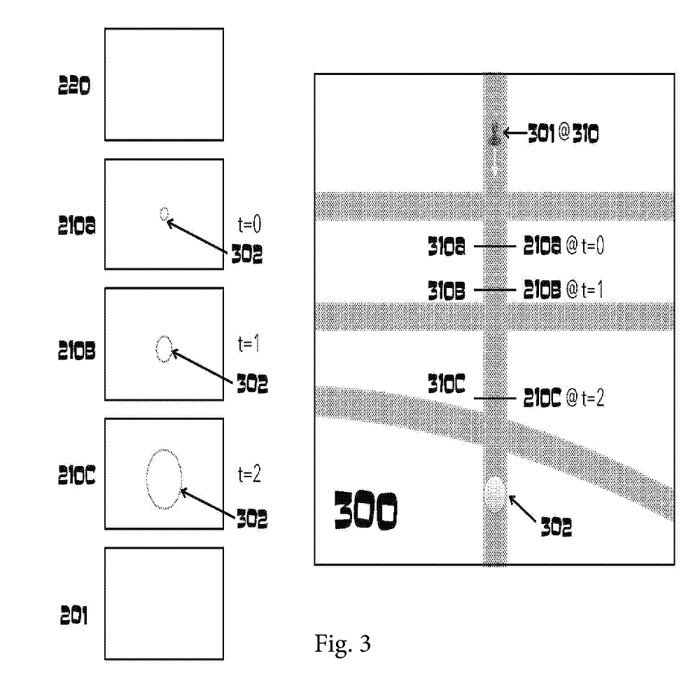

Looking at the left side of FIG. 3 one will see 5 layered panes. There is one dynamic instrument layer 201, three dynamic element layers 210, and one horizon layer 220. In this case the figure is illustrating how one may choose to render a virtual ball that is being rendered over real space. In this case, the ball has been rendered in three different sizes on our dynamic element layers 210, with the ball being the dynamic element. In FIG. 3, one can see that there is map 300 on the right side. With a virtual element 302 that has been placed on top of it. By way of example only 302 has been illustrated as a virtual ball that is to be overlaid over real space, though the virtual object may take on any form and may be animated. In this case, our direction of travel is downward as indicated by the white arrow toward the top of the map. One should also note that there are three dynamic element layers 210A, 210B, 210C that have been indicated on the map 300. In this case each of the layers will be activated once the user 301, located at the top of the map passes through each of the locations that our layers have been placed. In this case the user has been tagged with GPS coordinates 310. The user's GPS coordinates will change based on his location. The dynamic element layers 210 also have GPS tags 310A, 310B, and 310C associated with them. In this case 310A, 310B, 310C are fixed coordinates. This enables one to write a code using a do-while 420 or similar loop that would keep layer 210A active and all elements drawing on invisible pane 210A visible until the users coordinate 310 enter the zone between 310B and 310C. Note than in this case the ball 302 that is drawn on 210A, 210B, and 210C has not been animated in any way that appropriately reflects the ball size for times between t=0 and t=1, between t=1 and t=2, and for times greater than t=2. This means that if one were to drive down the street, the ball 302 would appear to suddenly get larger discreetly at points 310A, 310B, and 310C. This would yield a choppy effect that would not be desired by the user.

Another embodiment of the present invention includes the use of the left and right temples to aid the wearing during various system operations or application functions such as, by way of example only, navigation software operations. This may include, for example, when a route requires an up-coming left or right turn, the system can send a signal to provide an additional stimulus or queue, in addition to visual queues from the display. For instance, the system can provide a vibration in the left or right temple indication an upcoming left or right hand turn or maneuver. Additionally, audible sounds or beeps could be provided to the wearer of the AR glasses to further alert the wearing of upcoming actions required by the wearer.

As illustrated in FIG. 3A, the vibration could be facilitated through piezoelectric elements 333 and 334 inside or on the temples of the frame. Sound can also be produced by piezoelectric elements or by tiny speakers inside the temples.

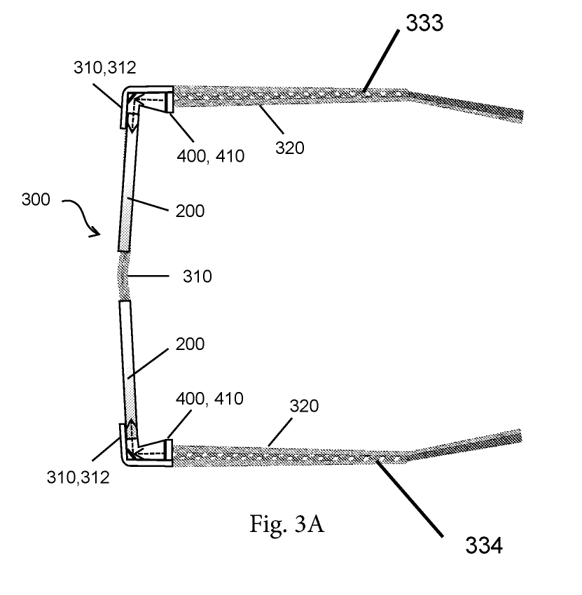

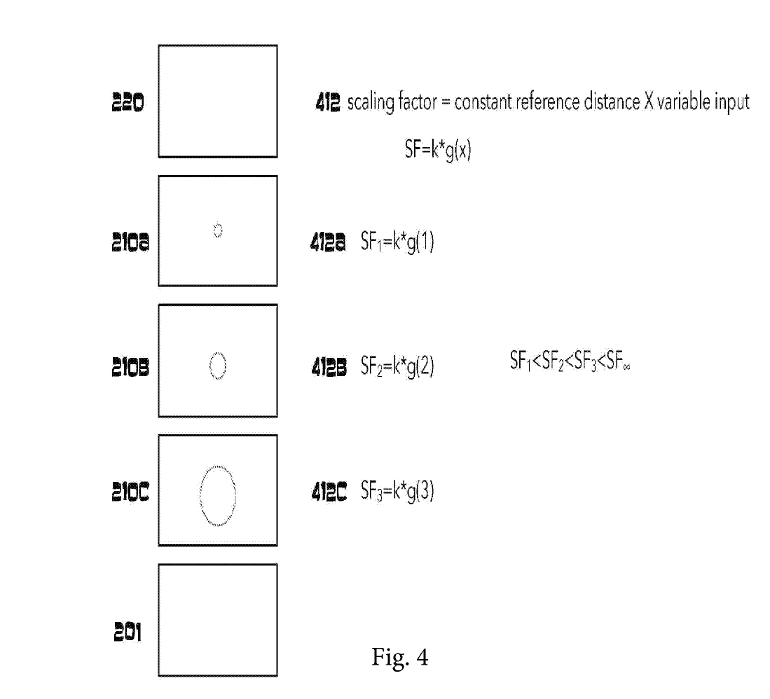

A method to explain how one may choose to render the virtual ball 302 (FIG. 3) in a way such that the ball appears to get gradually larger as one gradually gets closer to its location is that is explained in FIG. 4. One the left side of figure one can see the five layers that were previously described. In this case a scaling factor 412 has been applied to each 210. 412 is defined as reference distance which is constant or ‘k’ multiple times some other function g(x) or SF=k*g(x). In the case illustrated in FIG. 3, where each of the images 302 on the planes 210 did not change in size until the next 310 was passed, the equation for scaling factor would have been SF=k, with 210A, 210B, and 210C each having a different value for k. The case in FIG. 3 can also be expressed in the matrix notation below.

$$\begin{matrix}\begin{matrix}\begin{matrix}210 \\ A\end{matrix} \\ B\end{matrix} \\ C\end{matrix} [ \begin{matrix}k & g ( x ) & coord \\ 1 & 1 & 310 A \\ 1 + n & 1 & 310 B \\ 1 + m & 1 & 310 C\end{matrix} ]$$

In the case illustrated in FIG. 4, the matrix may take on this general form.

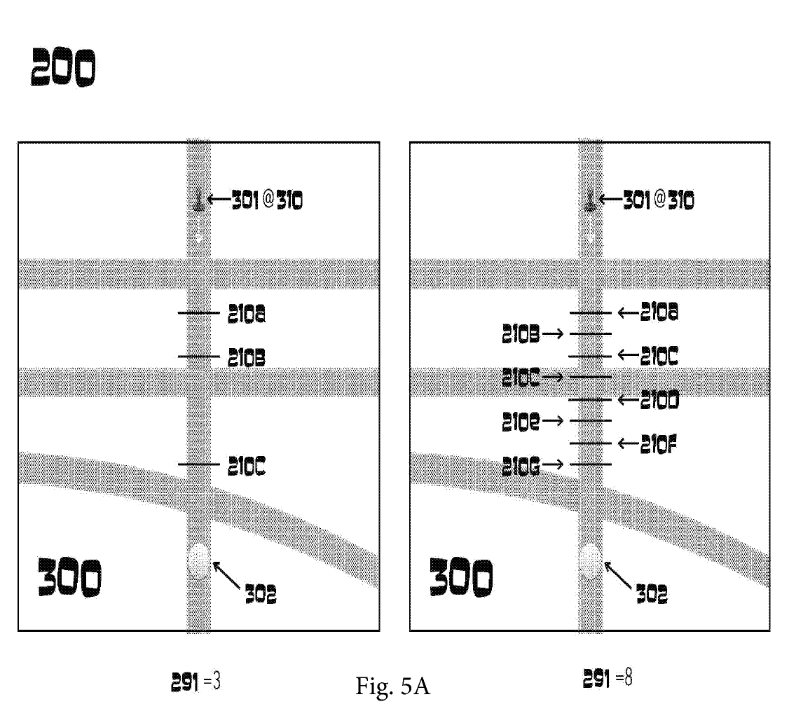

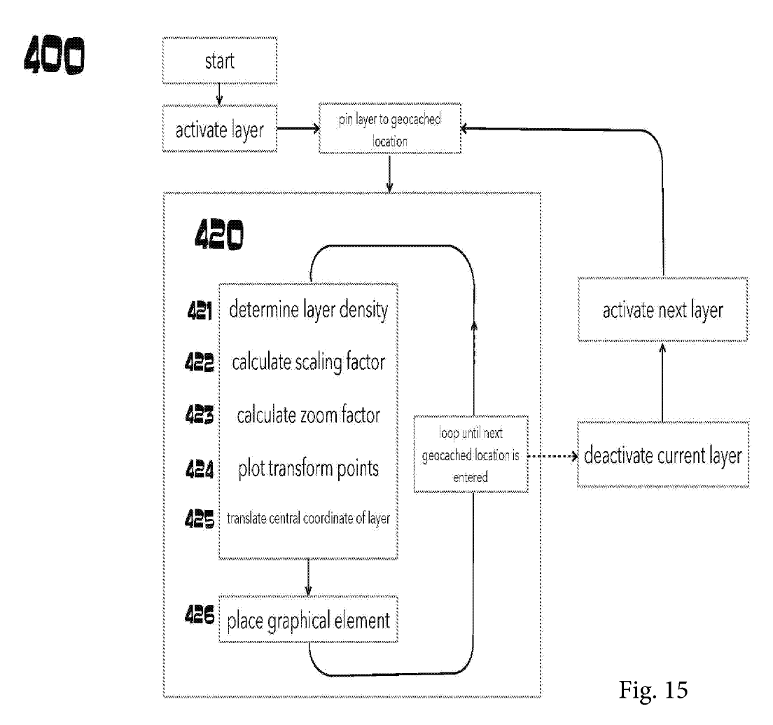

Though g(x) may be any equation, for this example we have chosen g(x)=x². The variable “x” could be a distance, a velocity, an acceleration, an angle, a time or something else. The idea here is to show an alternate way to convey the parameters of the scaling factor. In the case where g(x) is not constant, it acts as a transform factor in a matrix or Cartesian plan. Looking at FIG. 4a, one can see the effect of the scaling factor on the drawing. In this case even though the diameter of the circle is the same on all three drawings the same the scaling factor makes the circle appear larger. For this case, the variable “x” in the scaling factor equation may be used to represent distance travelled. This distance travelled can be calculated from a stream of GPS data as described in FIG. 15. Looking again at FIG. 4, we have selected 3 snapshots in time of dynamic element plane 210A, x=1, 2, and 3. Note the change of scale on the axes. Now looking at FIG. 6, one can see a different was to demonstrate this concept with the illustration on the left side of FIG. 6 showing various 210's with fixed scaling factors and on the right a method of using scaling factor with a piece-wise function. The reason why one may want to use this method is that it requires less data transfer between the device outputting the overlay to the user's field of vision and the device having to create planes. The main benefit is that a developer can make an app using fewer dynamic element planes 210 which yield lower processing power by having to turn fewer 210s on and off and having to draw, render, or otherwise render fewer unique graphics on each plane. While the present description of the invention has been discussed in Cartesian coordinates, other coordinate systems, such by way of example only, cylindrical, polar, or spherical systems may also be used where such systems would simplify operation or improve user experience regarding the placement of content in the scene or otherwise manipulating data or information for the user to see or experience.

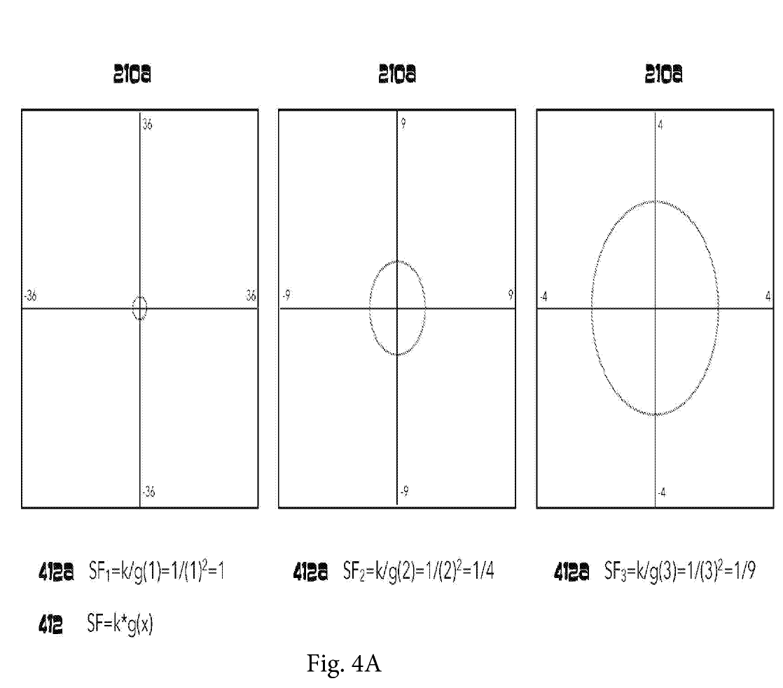

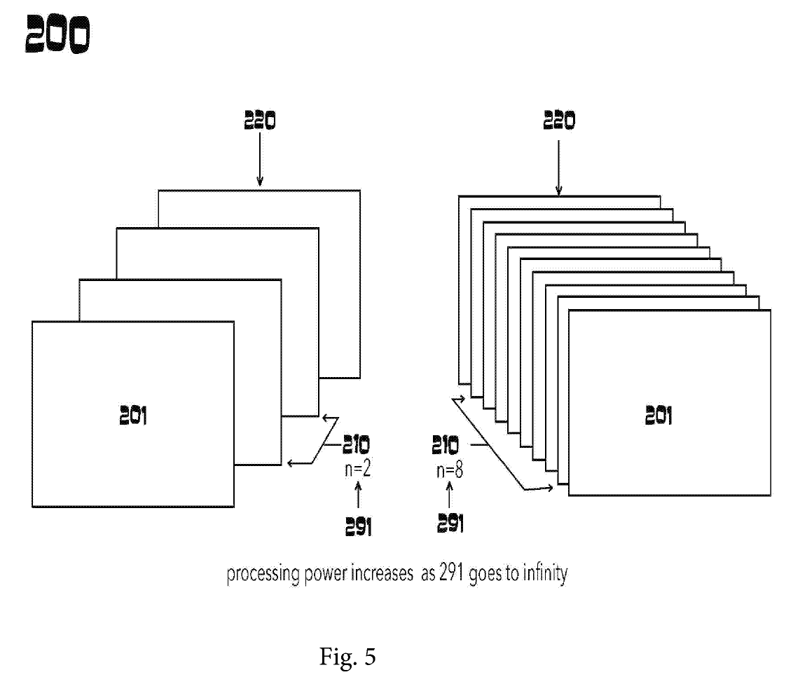

Performing this method may create performance that is choppy or inconsistent in certain scenarios. If more processing power is available, one may simply increase the dynamic element plane density 291. The dynamic element plane density may be defined as the number of dynamic element planes in a given distance, such as eight dynamic element planes per block, the number of 210's after 201, or the number of 210's before 220. This method requires more processing power as there is simply more information to process as each 210 would have a unique still drawing or animation that is needed to be drawn on it, and relevant GPS information 310 tagged to it. Using the method described above and in FIG. 15, one may realize a less choppy experience. Note FIG. 5a shows a vertical illustration of the location of each 210 in different densities.

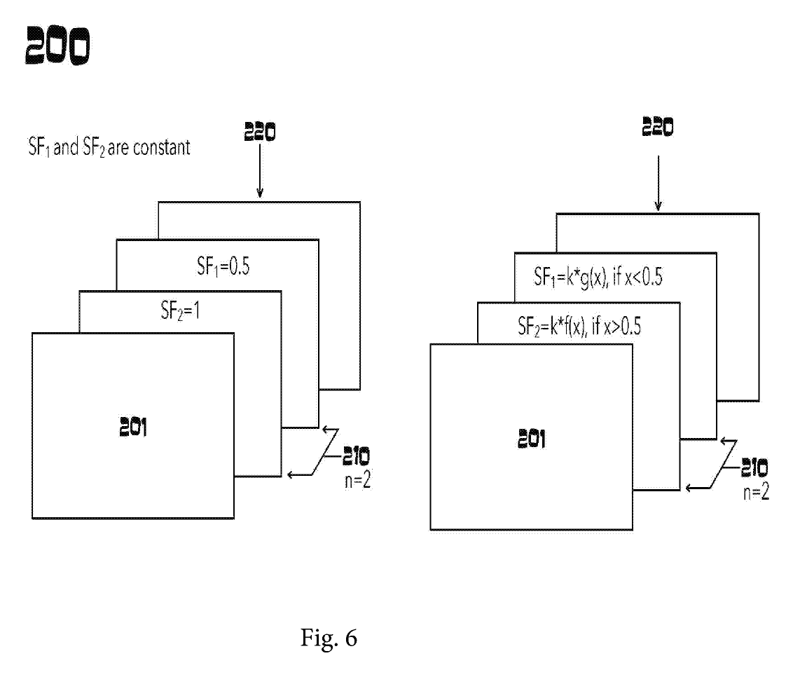

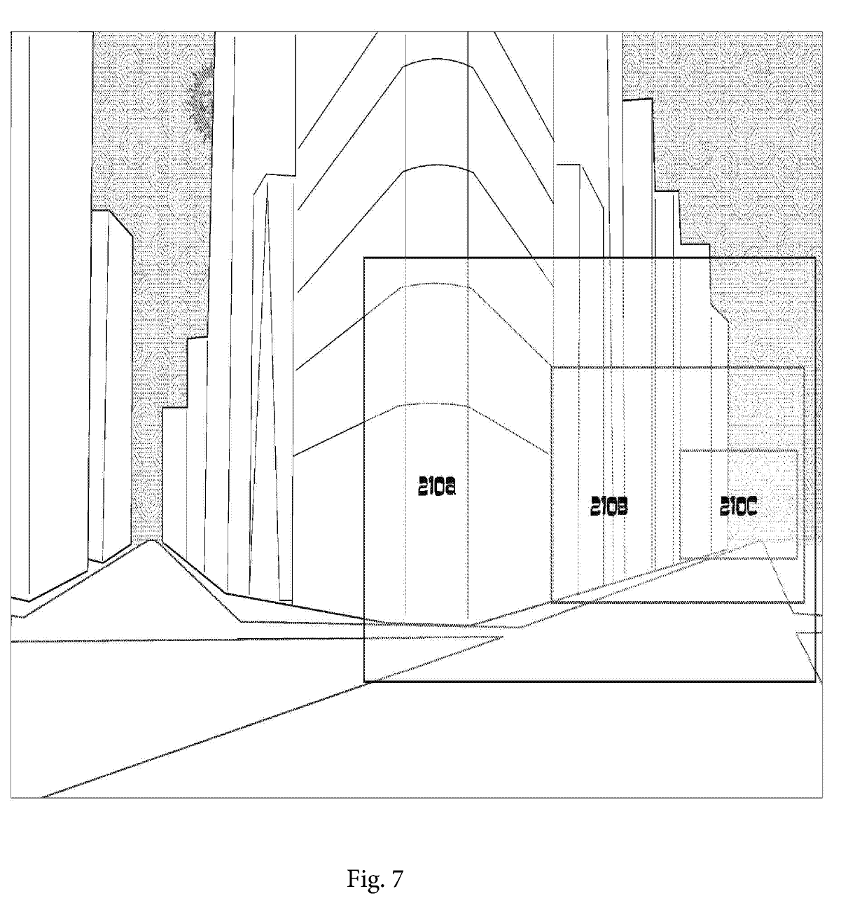

In certain applications, a developer may wish to create software where multiple 210s are being used simultaneously. FIG. 7 shows a street view with three 210s on it. Again, note that 210A, 210B, and 210C are invisible to the wearer and are drawn in to more easily explain the concept. In FIG. 8, one sees a chevron 500 has been transformed for a navigational purpose of directing a user down a street a number of block and making a left turn. In the case shown in FIG. 8 210A, 210B, 210C are all active, but the transformed chevron 500 is only being drawn on 210A, nothing is being drawn on 210B, and a street name (not pictured) may be drawn on 210C.

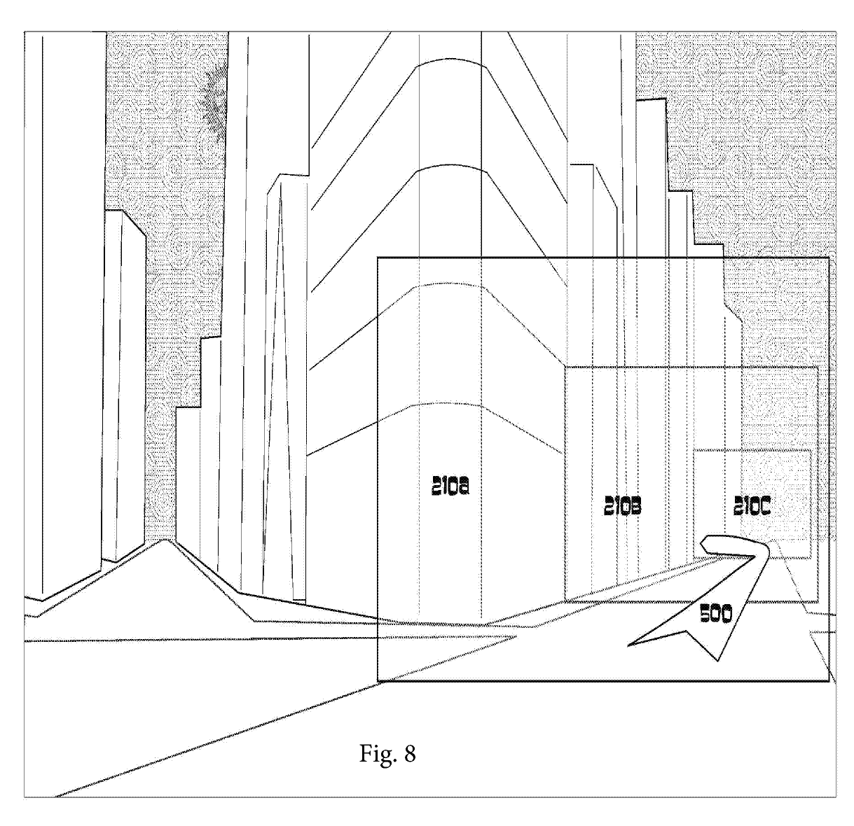

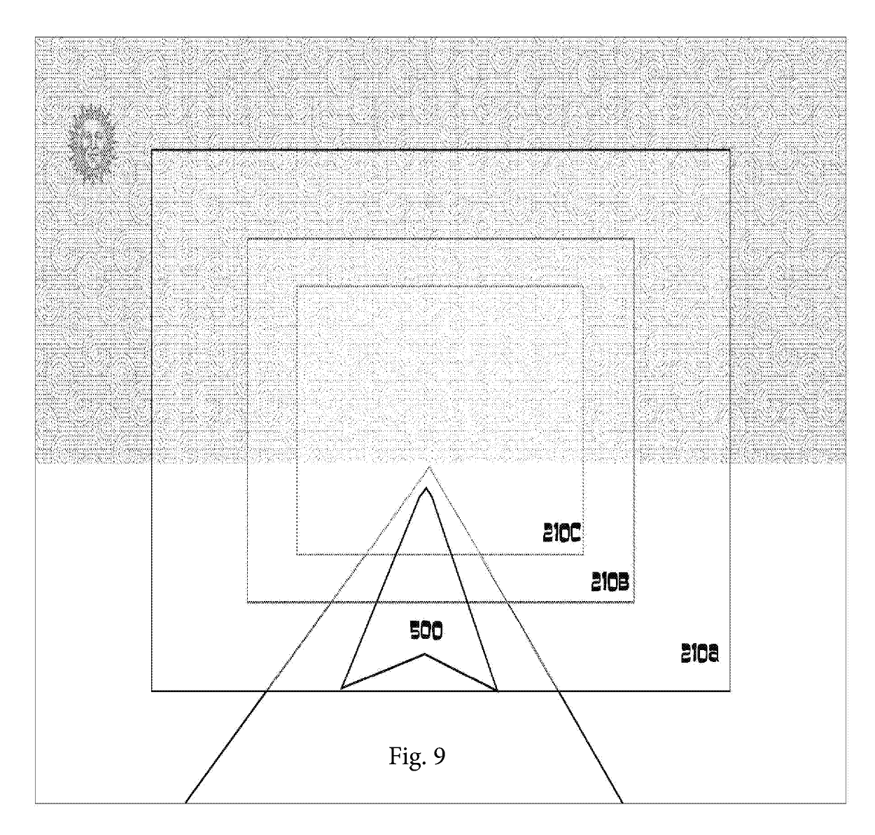

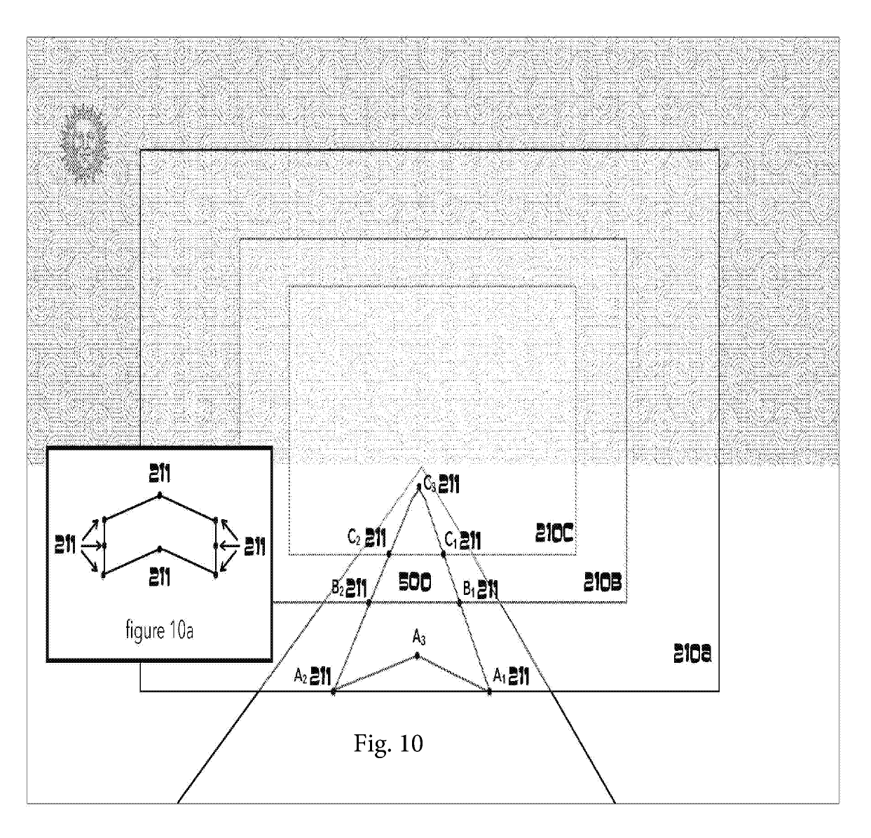

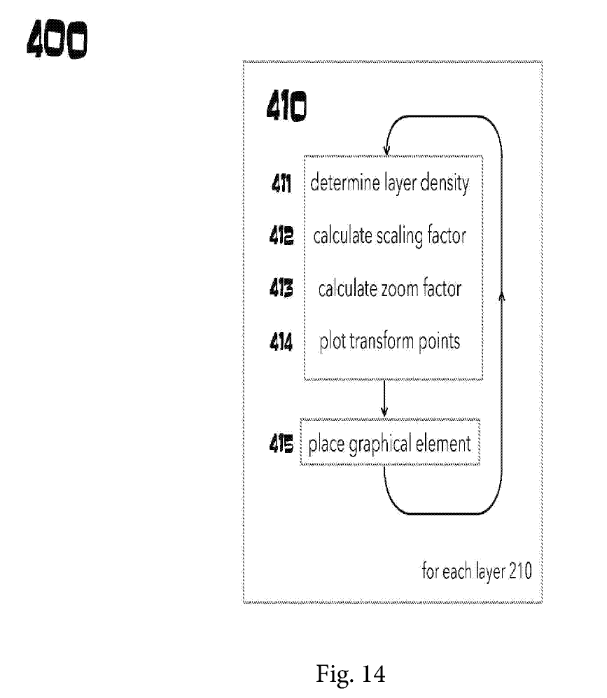

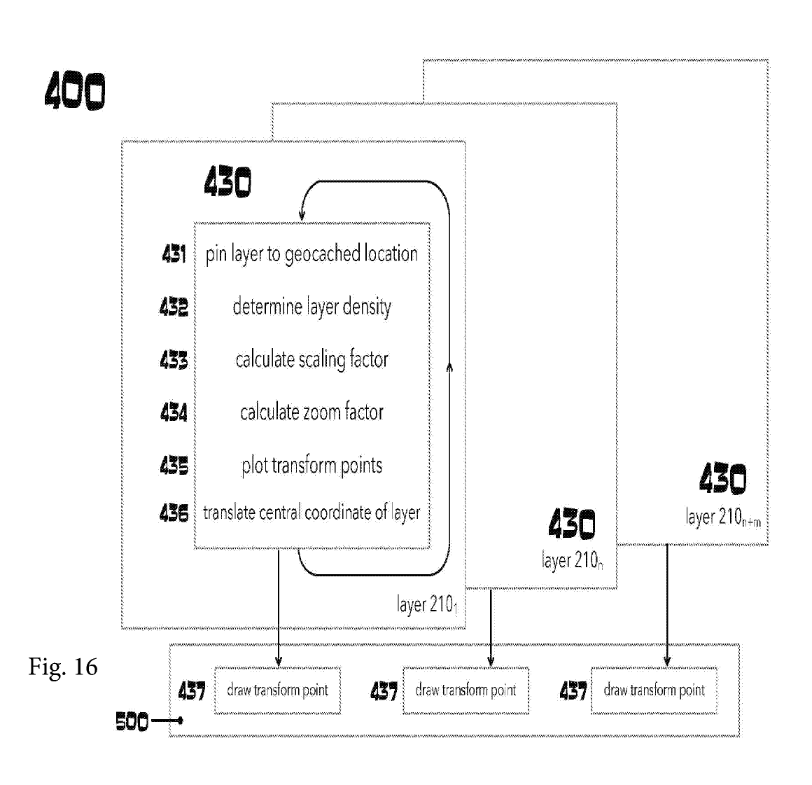

In another application of the invention, a developer may wish to draw, transform, or otherwise render a graphic by plotting points on a number of the planes simultaneously. FIG. 9 shows a final result of this. Looking at FIG. 10, one can see how this was achieved. In this case a vectorized image 500 of chevron has been transformed by adding certain sharp transform point 211 to it. Note that vectorized image may be any image, character, or animation, but is shown as a chevron by way of example only. Sharp transform points 211 A1 and A2 correspond to points plotted on 210A, points B1 and B2 correspond to points plotted on 210B, and points C1, C2,C3 correspond to points plotted on 210C. FIG. 10A shows the original chevron 500 before it was transformed as illustrated in FIG. 10. In the case illustrated on FIG. 10, the origins 290 (see FIG. 2) of 210A, 210B, and 210C are concentric. In order to render, draw and transform all of this in accordance with this method, look at FIG. 16. On this figure, one can see a high level computer program flow chart 430. Steps 431 through 436 sequentially looped yield the drawn result 437 on the viewer's field of vision 500. Note that 437 is redrawn at the end of each loop and the previous 437 is erased. Also note that in this case 430 is being drawn simultaneously on each 210. However, note that some of the 210's may function in accordance with the operation on FIG. 14, where the computer program 420 is being used by following steps 421 through 426 certain layers can be turned off while other can be drawn on.

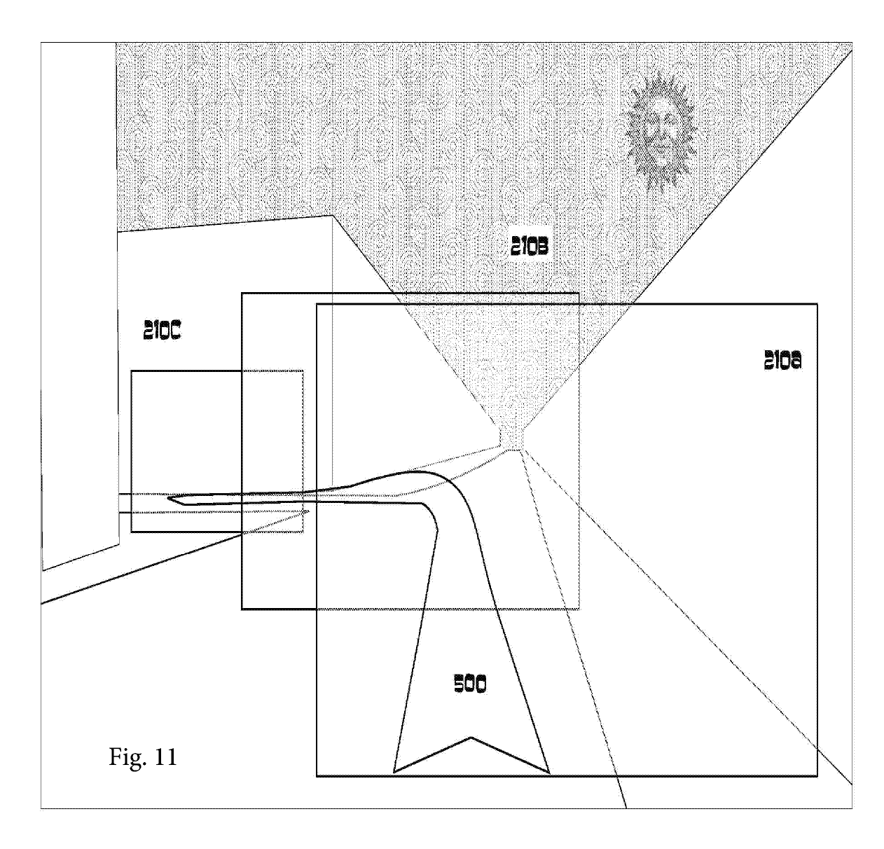

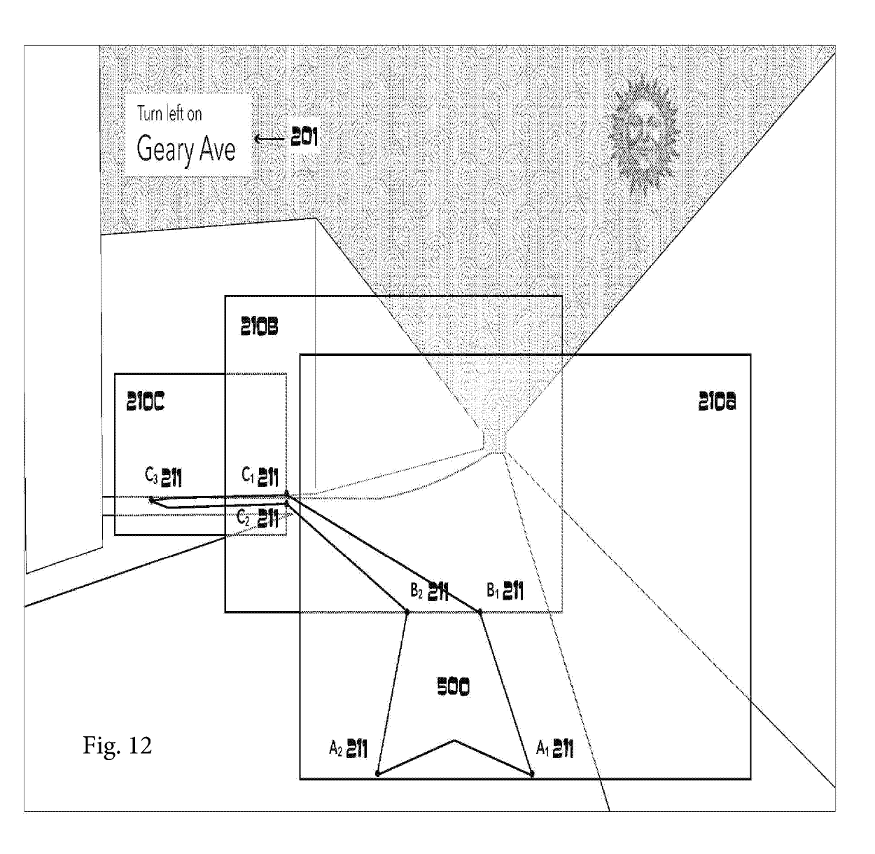

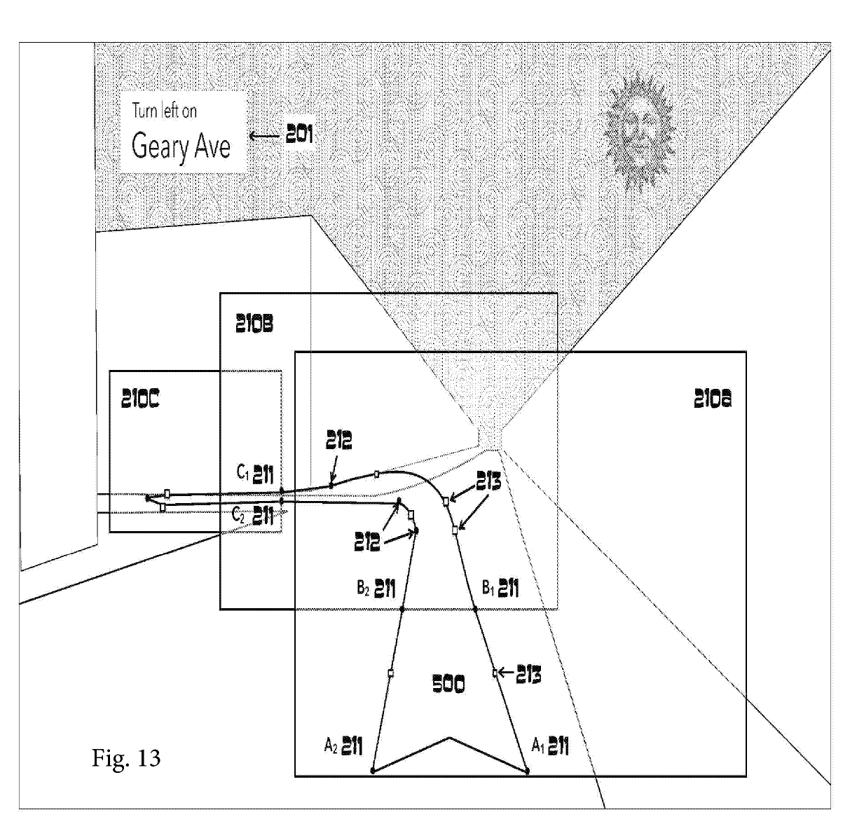

In other embodiments, a developer may wish to develop software where the center 290 of each 210 are not concentric and may have been translated about the center of a person's field of vision in some way as shown in FIG. 11. If one simply translates the 210's in FIG. 10 to the left one may yield a result as illustrated in FIG. 12. Note that the 211 create angles in this transformation. Looking at FIG. 13, one can see that by adding intermediate sharp points 212 to and soft points 213 the original chevron the view will view a transformed chevron with smooth transitions between each point. The smooth points 213 may be defined as additional points that use a spline or similar curve function between it and its two adjacent points. The intermediate sharp point 212 may be defined as any sharp point that is not plotted on the border of 210. 211's in most cases are plotted on the border of 210. In order to render, draw and transform all of this in accordance with this method look at FIG. 16. On this figure one can see a high level computer program flow chart 430. Steps 431 through 436 sequentially looped yield the drawn result 437 on the viewer's field of vision 500. Note that 437 is redrawn at the end of each loop and the previous 437 is erased. Also note that in this case 430 is being drawn simultaneously on each 210. However, note that some of the 210's may function in accordance with the operation on FIG. 14, where the computer program 420 is being used by following steps 421 through 426 certain layers can be turned off while other can be drawn on.

In some embodiments, personal history and associations of the user and their specific GPS data may be used to adjust content specific to the user. For example, if a user is in a database of members of an organization, the system could allow for sharing of specific information regarding others and their particular GPS data to display content regarding the general location of other members in the near vicinity of the user.

In still other embodiments of the present invention, a neural network or other artificial intelligence means could be used where the collective data from numerous users with specific interests, histories, experiences, or the like could be sorted, filtered and displayed before the user in the local area near or around the user. The content volume could be preset to limit the amount of information displayed before the user, or the system could automatically adjust depending on amount of related content that becomes available from the network. In this manner a collective memory and “experience database” could be created and accessed that would provide content from multiple users with similar interests and experiences to the individual. Information could also be drawn from specific groups or subgroups on a social media website, by way of example only, Facebook, Linkedin, or others.

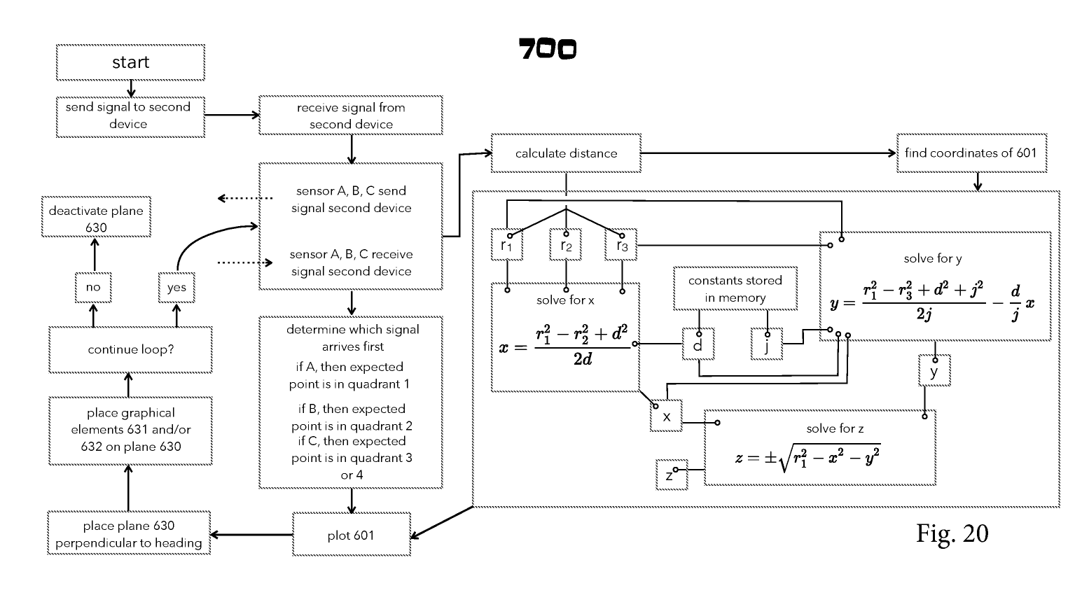

Alternative embodiments of the invention are shown in FIGS. 19 and 20. Further details of such embodiments can be found in U.S. Provisional Patent Application No. 62/191,752 filed 13 Jul. 2015, the entire disclosure of which is incorporated herein by reference. FIG. 19 shows a function 600 for determining the coordinates of an object 601 with respect to the user. While object 601 is shown as an automobile, it will be apparent to a person of skill in the art that such object could be any other object as well, including a building or a wireless router. In the case shown, the known coordinates of 620A, 620B, and 620C (with 620A residing at the origin) would be preloaded into the system. The distance between 620A and 620B is “j” or 622 the distance between 620B and 620 is “d” or 623. If one considers the points associated with 620A, 620B, 620C as center points to three spheres, they may described by the following equations:

r₁²=x²+y²+z²

r₂²=(x−d)²+y²+z²

r₃²=(x−dⱼ)₁²+(y−j)²+z²

601 has coordinate (x,y,z) associated with that will satisfy all three equations. In order find said coordinate the system first solves for x by subtracting r₁, and r₂.

r₁²−r₂²=x²−(x−d)²

Simplifying the above equation and solving for x yields the equation:

$$x = \frac{{r}_{1}^{2} - {r}_{2}^{2} + {d}^{2}}{2 d}$$

In order to solve for y, one must solve for z in the first equation and substitute into the third equation:

$${z}^{2} = {r}_{1}^{2} - {x}^{2} - {y}^{2}$$

$${r}_{3}^{2} = {( x - d )}^{2} + {( y - j )}^{2} + {r}_{1}^{2} - {x}^{2} - {y}^{2}$$

$${r}_{3}^{2} = ( {x}^{2} - 2 xd + {d}^{2} ) + ( {y}^{2} - 2 yj + {j}^{2} ) + {r}_{1}^{2} - {x}^{2} - {y}^{2}$$

$$y = \frac{- 2 xd + {d}^{2} + {j}^{2} + {r}_{1}^{2} - {r}_{3}^{2}}{2 j}$$

$$y - \frac{{r}_{1}^{2} - {r}_{3}^{2} + {d}^{2} + {j}^{2}}{2 j} - \frac{d}{j} x$$

### Simplifying:

At this point x and y are known, so the equation for z may simply be rewritten as:

z−⊥√r₁²−x²−y²

Since is not an absolute value it is possible for there to be more than one solution. In order to find the solution, the coordinates can be matched to the expected quadrant which ever coordinate does not match the expected quadrant is thrown out. FIG. 20 illustrates how the above operations may be looped with software 700.

At least some aspects disclosed above can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. Information, instructions, data, and the like can also be stored on the cloud or other off device storage network or medium. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A method for displaying a virtual image in a field of vision of a user without the use of an image sensor, comprising:
receiving first data identifying a user's first location;
using the first data to estimate the user's first location;
using the estimate of the user's first location to identify at least one user interface element or active element within the user's field of vision;
associating the at least one user interface element or active element with one of a plurality of layered planes in a virtual space; and,
displaying a first version of the user interface element or active element within a first field of vision of the user.

2. The method for displaying a virtual image according to claim 1, further comprising:
receiving second data identifying the user's updated location;
using the second data to estimate the user's updated location;
using the estimate of the user's updated location to update appearance of the representation of the user interface element or active element within a second field of vision of the user.

3. The method for displaying a virtual image according to claim 2, wherein the representation of the user interface element or active element is updated in scale in the second field of vision of the user.

4. The method for displaying a virtual image according to claim 1, wherein the first data comprises GPS data.

5. The method for displaying a virtual image according to claim 1, wherein the plurality of layered planes comprise a dynamic instrument layer.

6. The method for displaying a virtual image according to claim 1, wherein the plurality of layered planes comprise a dynamic element layer.

7. The method for displaying a virtual image according to claim 1, wherein the plurality of layered planes comprise a horizon layer.

8. The method for displaying a virtual image according to claim 1, wherein the layered planes' origins are directly overlapped and concentric.

9. The method for displaying a virtual image according to claim 1, wherein the layered planes' origins have been translated.

10. The method for displaying a virtual image according to claim 1, wherein the layered planes' origins have been rotated.

11. The method for displaying a virtual image according to claim 1, wherein the layered planes' origins have been transformed.

12. The method for displaying a virtual image according to claim 1, wherein graphics on at least one of the layered planes have been deactivated or rendered not visible.

13. The method for displaying a virtual image according to claim 1, wherein graphics are drawn on one plane that are different from what is being drawn on another plane.

14. The method for displaying a virtual image according to claim 13, wherein the planes' origins are directly overlapped and concentric.

15. The method for displaying a virtual image according to claim 1, wherein one or more graphics are being drawn, mapped, transformed on more than one plane simultaneously.

16. The method for displaying a virtual image according to claim 1, wherein at least one plane is placed and mapped in virtual space to display character outputs from one or more sensors on a first plane and wherein second through ‘n’th planes display graphics and characters as an output of second, third, or ‘n’th software program.

17. The method for displaying a virtual image according to claim 1, wherein two or more planes are placed and mapped in virtual space, and wherein said planes have the same scale applied to their respective coordinate systems.

18. The method for displaying a virtual image according to claim 17, wherein the scales on all planes change based upon the same equation.

19. The method for displaying a virtual image according to claim 1, wherein two or mores plane are placed and mapped in virtual space, and wherein said planes have a plurality of scales applied to their respective coordinate systems.

20. The method for displaying a virtual image according to claim 19, wherein the scales on all planes change based upon the same equation.

21. The method for displaying a virtual image according to claim 19, wherein the scales on all planes change based upon a unique equation for each plane.

22. The method for displaying a virtual image according to claim 21, wherein the scales on at least 2 of the planes are equivalent.

23. The method for displaying a virtual image according to claim 19, wherein said system further utilizes eye tracking data.

24. The method for displaying a virtual image according to claim 23, further comprising a step of using the eye tracking data to translate, rotate, or otherwise modify or transform the coordinate system used to display information to the user of the system.

25. The method for displaying a virtual image according to claim 19, further comprising a step of using information from a collective memory or experience database developed from data collected or provided by other users of a similar system.

26. The method for displaying a virtual image according to claim 25, further including a step of using a neural network or other means of artificial intelligence.

27. The method for displaying a virtual image according to claim 25, wherein the information is displayed based on the user specific membership in groups or contacts from a social media website.

28. The method for displaying a virtual image according to claim 1, wherein a stimulation is provided to the user's left and/or right temple to aid in a function of a mediated reality device.

29. The method for displaying a virtual image according to claim 1, wherein the first data comprises data from a wireless router.
